(19) United States
(12) Patent Application Publication
(10) Pub. No.: US 2011/0162421 A1
(43) Pub. Date: Jul. 7, 2011

(54) Renewable Process for Manufacturing Ground and Soil Treatment Compounds Using Plant By-Products and Plant Waste

(76) Inventors: Michael Maffei, Entiat, WA (US); Wesley A. Maffei, Vallejo, CA (US)

(21) Appl. No.: 12/813,957

(22) Filed: Jun. 11, 2010

Related U.S. Application Data
(63) Continuation-in-part of application No. 11/441,750, filed on May 26, 2006, now Pat. No. 7,736,411.

(51) Int. Cl. C05F 11/00; C09K 3/14

(52) U.S. Cl. 71/23; 106/36

(57) ABSTRACT

The invention relates to a renewable process for manufacturing ground and soil treatment compounds using plant waste and plant by-products. The invention further relates to products of that process, including an anti-slip compound for use on snow- or ice-covered surfaces, and to a related fertilizer compound for improving plant growth. The described compounds primarily comprise plant waste and organic by-products of timber processing operations and agricultural operations. In addition, the invention relates to a renewable energy and resource process.

### CROSS-REFERENCE TO RELATED APPLICATIONS

This application is a continuation-in-part of currently pending application Ser. No. 11/441,750 filed May 26, 2006.

### STATEMENT REGARDING FEDERALLY SPONSORED RESEARCH OR DEVELOPMENT

Not applicable

### NAMES OF PARTIES TO JOINT RESEARCH AGREEMENT

Not applicable

### BACKGROUND OF THE INVENTION

1. Field of the Invention

The invention relates to a renewable process for manufacturing ground and soil treatment compounds using plant by-products and plant waste. The invention further relates to products of that process, including an anti-slip compound for use on snow- or ice-covered surfaces, or in any location where improved traction is desirable for pedestrian and traffic safety, and to a related fertilizer compound for improving plant growth. The described compounds primarily comprise plant waste and organic by-products of timber processing operations and agricultural operations. In addition, the invention relates to a renewable energy and resource process.

2. Description of Related Art

The need for anti-slip compounds is generally well-known in areas where winter weather brings precipitation and low temperatures. Ice- and snow-covered surfaces are a potential hazard for pedestrian and vehicular traffic, leading to injuries, property damage, traffic delays and blockages. In recognition of this hazard, many products have been developed to provide friction on slippery surfaces, or to melt accumulated ice or snow, or both.

One class of products that has been developed to treat ice- and snow-covered surfaces is deicers. Chemical deicers in either liquid or solid form are applied to road surfaces to melt surface ice and improve traction. While effective in removing ice, some salt-based chemical deicers are undesirable for long term use because of their corrosive properties. Furthermore, many chemical deicers have an adverse impact on the environment in which they are applied. Another class of products that is used to treat ice- and snow-covered surfaces is abrasive materials. Substances such as sand, gravel, cinders and the like are commonly spread on ice- and snow-covered surfaces to provide improved traction for pedestrian and vehicular traffic.

Combinations of chemical deicers and abrasive materials are also well known in the treatment of snow and ice covered surfaces. U.S. Pat. No. 2,410,910 to Wait for “Material for Providing Traction” describes a method for making a traction-providing material, involving the impregnation of an insoluble porous particulate material with an aqueous salt solution. The more recent U.S. Pat. No. 5,965,058 to Janke et al. for “Deicing Composition and Method” discloses a deicing composition formed from steepwater solids, a byproduct from the wet milling of corn. In an embodiment of the '058 invention, traction-providing material such as sand or sawdust is added to the deicing composition.

The use of fertilizers to enhance plant growth is well established in modern agriculture. Myriad mixtures of beneficial soil amendments are available commercially, including those comprising primarily organic ingredients. It has been recognized for centuries that, when mixed with soil, ash provides a variety of major and minor elements necessary for plant growth. Likewise, the use of sawdust as a soil amendment or mulch is well known.

### BRIEF DESCRIPTION OF THE DRAWING

FIG. 1 is a flow chart showing an embodiment of the present invention.

### DETAILED DESCRIPTION OF THE INVENTION

The present invention provides an environmentally friendly soil and ground treatment compound useful for providing friction to slippery surfaces, and for fertilizing trees and other plants, referred to herein as “ground treatment compound.” In general, the ground treatment compound comprises a wood product particulate, ash, and a moisture source.

The wood product particulate component of the ground treatment compound may be obtained from a number of sources. Sawdust from timber milling or processing operations is an excellent source of wood product particulate. Timber mills and manufacturing facilities produce sawdust as a by-product in the processing or manufacturing of traditional forest products. Sawdust is used in pulp and paper milling, pellets for pellet stoves, animal bedding, and fuel for energy and heat generation, but environmentally responsible disposal of excess sawdust often remains an issue for owners and operators of timber mills and manufacturing facilities. In light of its availability and low procurement cost, sawdust is a preferred wood product particulate according to the present invention. Other wood product particulates, such as chipped plant waste may also be used as the wood product particulate component of the invention.

In an alternative embodiment, finely shredded, dried plant material such as grasses and leaves may be added as a component of the wood product particulate. The addition of grasses and leaves is preferred only when the ground treatment compound is to be used as a fertilizer.

The invention further comprises an ash component. In a preferred embodiment of the ground treatment compound used as an anti-slip agent, the ash component is a fine light grey or white ash derived from the combustion or gasification of plant materials. The fine texture is advantageous in that it mixes evenly with and adheres to the wood product particulate component. Light grey or white ash is ideal because it does not discolor ground surfaces, nor does it leave significant marks when tracked indoors. Additionally, light colored ash washes off more easily than darker ash, and tends to have less odor than darker ash.

When the ground treatment compound is to be used as a fertilizer, the ash component is preferably a high carbon black ash, although light grey or white ash can also be used.

Wood ash, like sawdust, is generated as a byproduct of an industrial process. Industrial combustion or gasification of wood for the generation of power results in production of wood ash, which is often used as a soil amendment or disposed of in landfills. Wood ash is readily available, often at or near sources of wood product particulate such as sawdust, and is therefore a preferred component of the claimed compound.

In an alternative preferred embodiment, ash derived from the combustion of vineyard waste or orchard waste is used. Vineyard waste, comprising leaves, branches, unusable fruits, and the skin and seed waste remaining after the crushing process, makes an excellent ash when burned completely. Orchard waste, comprising leaves, branches, unusable fruits, and fruit waste also provides high quality ash. Ash derived from walnut and almond shells is also useful as an ash source.

In an additional embodiment, ash derived from the burning of grasses is used. Early attempts by the inventors to obtain the ash component from grasses such as wheat, barley, wild oats, corn, bamboo and lawn cuttings were unsuccessful, due to the incomplete combustion of the grasses in a typical combustion chamber. The build-up of black soot or “clinker” in the combustion chamber rendered the combustion of grasses unworkable. Additionally, the ash resulting from the combustion process was dark and sooty, and therefore not usable because of the tendency of the ash to mark or stain walkways. After experimentation, it was discovered by the inventors that usable ash from grasses can be obtained by more thoroughly combusting the grasses. This is achieved by burning the grasses in a better oxygenated, and therefore hotter, fire. The resulting ash is fine and light in color, and is a viable source of ash for the ground treatment compound claimed herein.

According to the invention, a quantity of wood product particulate is mixed with a quantity of ash. In an embodiment, the wood product particulate is first exposed to a moisture source to lightly moisten the surface of the wood product particulate. The addition of moisture to the wood product particulate results in adhesion of the ash to the surface of the wood product particulate, which aids in the homogeneous mixing of the ash and the wood product particulate. By way of example but not limitation, moisture treatment of the wood product particulate can be accomplished by briefly exposing the wood product particulate to a vapor or mist source. Excessive exposure to moisture can result in formation of mold on the wood product particulate, while insufficient moisture can lead to non-homogeneous mixing of the wood product particulate and the ash. In a preferred embodiment, the wood product particulate is treated at a rate of two gallons of a moisture source to 5.5 tons of wood product particulate (approximately 7.5 liters per 5 metric tons).

In an embodiment of the invention, the moisture source to which the wood product particulate is exposed is water, preferably in the form of vapor or mist.

In an additional embodiment, the moisture source includes a binding agent. The use of a binding agent with the moisture source improves adhesion of the ash to the wood product particulate. Preferably the binding agent is mixed with or dissolved in water for application to the wood product particulate. In one preferred embodiment, the moisture source is a dilute solution of a plant derived terpene-containing compound. Turpentine, a readily available terpene-containing compound, is a preferred example of such a solution. A solution containing about three percent to ten percent (3% to 10%) turpentine by volume produces the desired effect. Most preferably, the dilute turpentine solution contains approximately five percent to ten percent (5% to 10%) turpentine by volume.

Other binding agents are also contemplated. The inventors experimented with dilute solutions of terpene- and terpenoid-containing compounds and plant-derived oils. Fruit and vegetable waste was also tested as a moisture source. It was discovered that compounds containing plant derived terpenes, including but not limited to lemon and orange oils, are particularly effective as a moisture source when mixed with water in the same ratios as discussed above with turpentine. Turpentine is preferred because of its relatively low cost and general availability, but lemon and orange oils are also readily available. Compounds containing plant-derived terpenoids have also been found to be effective as a moisture source when mixed with water. These compounds include but are not limited to eucalyptus, camphor, basil, rosemary, sage, and citronella oils. Due to their limited availability and higher cost, these compounds are not preferred, but nonetheless are workable alternative embodiments.

Plant-derived oils, when mixed with water, can also serve as binding agents. Neem, soybean, peanut, corn, canola, castor, olive, sunflower and sesame oils have been used with varying degrees of success. In general, the inventors have found that the less viscous oils are more effective because they can be agitated with water and suspended for a longer period of time, thus allowing for a more even application of the moisture source to the wood product particulate. A mixture containing about three percent to ten percent (3% to 10%) plant-derived oil by volume produces the desired effect. Most preferably, the mixture contains approximately three percent to four percent (3% to 4%) plant-derived oil by volume.

Ground treatment compounds made with plant oils as a binding agent have been found to develop a mild rancid odor after extended storage, and are therefore not a preferred embodiment for use after an extended storage period.

The inventors have experimented with the use of fruit and vegetable waste as a moisture source for the ground treatment compound of the present invention. Experiments have been conducted using apples, apple skins and seeds, apple sludge, pears, pear skins and seeds, grapes, grape skins and seeds, winery waste, tomatoes and tomato skins, and potatoes and potato skins. It has been found that although such waste material can be used, its use is problematic due to the potential for odor, mold and the attraction of insects.

According to the invention, after the wood product particulate is exposed to a moisture source, it is combined with a quantity of ash. Preferably, the moisture treated wood product particulate and the ash are mixed in a ratio of approximately eighty percent to ninety percent (80% to 90%) wood product particulate to approximately ten to twenty percent (10% to 20%) ash by volume. Wood product particulate and ash mixed in these ratios are effective in producing the desired result of providing improved traction on ice- or snow-covered surfaces, and providing enhanced growth of trees and other plants. The compound is particularly useful as an anti-slip compound when mixed at a ratio of eighty-five percent (85%) wood product particulate to fifteen percent (15%) ash. A compound having a ratio of eighty percent (80%) wood product particulate to twenty percent (20%) ash has been proven to be particularly effective as a fertilizer.

In an embodiment, the present invention provides an environmentally responsible method for improving traction on ice- or snow-covered surfaces. The method includes the steps of obtaining a wood product particulate; exposing the wood product particulate to a moisture source; mixing the moisture treated wood product particulate with a quantity of ash; and applying the resulting compound to ice- or snow-covered surfaces by mechanical or manual means. The anti-slip compound is particularly advantageous when used in environmentally sensitive areas. Because the anti-slip compound consists primarily of plant byproducts, it is harmless to plant growth and wildlife. The absence of inorganic salts is also an advantage, in that use of the anti-slip compound does not result in corrosion of surfaces with which the compound comes in contact.

In a further embodiment, the present invention provides a method for improving traction on ice- or snow-covered surfaces and providing a nutrient source for surrounding vegetation. The method includes the steps of obtaining a wood product particulate; exposing the wood product particulate to a moisture source; mixing the moisture treated wood product particulate with a quantity of ash; and applying the resulting compound to ice- or snow-covered surfaces and surrounding vegetation by mechanical or manual means.

In a further embodiment, the present invention provides a method for fertilizing plants. The method includes the steps of obtaining a wood product particulate; exposing the wood product particulate to a moisture source; mixing the moisture treated wood product particulate with a quantity of ash; and applying the resulting compound to the soil surrounding trees and other plants by mechanical or manual means. The inventor has achieved particular success using the compound to promote rapid growth of pine trees in low water areas.

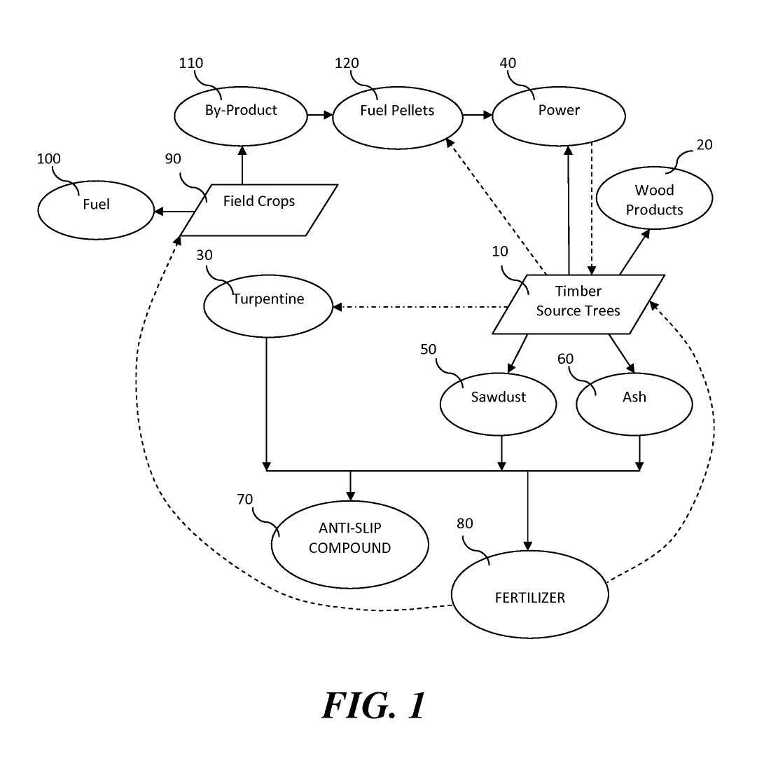

The compound described above, as well as its uses and methods of manufacture, are part of a larger, environmentally sustainable process, as depicted in FIG. 1. According to the process, a timber processing operation processes timber 10 to produce wood products 20 for distribution and sale. Turpentine 30 is an additional downstream product of the timber processing operation 10. Combustion of timber generates power 40. By-products of the timber processing operation 10 include sawdust 50 and ash 60. The compound of the present invention described above, in the form of an anti-slip compound 70 or fertilizer 80 can be manufactured from the sawdust 40, ash 50 and turpentine 30 produced as products or by-products of the timber processing operation 10. The anti-slip compound 70 produced by the process is used to improve traction on snow and ice-covered surfaces. The fertilizer 80 produced by the process is used to fertilize plants, and is cycled back into the process by fertilizing the timber 10 used in the timber processing operation.

According to the process of the invention, the fertilizer 80 is additionally used to promote growth and increase yield of field crops 90 such as wheat and other crops used in the production of renewable fuels 100 such as ethanol and bio-diesel. The production of fuel from plant matter results in the production of a plant matter by-product 110, which is pelletized and dried to create fuel pellets 120. The fuel pellets 120 are distributed and sold, and are also re-introduced in the cycle as a fuel source for the production of power 40.

In compliance with the statutes, the invention has been described in language more or less specific as to structural features and process steps. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

The following is claimed:

1. An environmentally friendly soil and ground treatment compound, the compound comprising:
a wood product particulate;
ash; and
a moisture source,
wherein the moisture source comprises water and a binding agent.

2. The compound of claim 1, wherein the binding agent is a plant-derived terpene-containing compound.

3. The compound of claim 1, wherein the binding agent is a plant-derived terpenoid-containing compound.

4. The compound of claim 1, wherein the binding agent is a plant-derived oil.

5. The compound of claim 2, wherein the moisture source comprises water and approximately 3% to 10% by volume of the plant-derived terpene-containing compound.

6. The compound of claim 3, wherein the moisture source comprises water and approximately 3% to 10% by volume of the plant-derived terpenoid-containing compound.

7. The compound of claim 4, wherein the moisture source comprises water and approximately 3% to 10% by volume of the plant-derived oil.

8. The compound of claim 1, comprising approximately 80% to 90% wood product particulate by volume, and approximately 10% to 20% ash by volume.

9. A process for manufacturing an environmentally friendly soil and ground treatment compound, the process comprising the steps of:
obtaining a wood product particulate generated as a byproduct of a timber processing operation;
exposing the wood product particulate to a moisture source;
obtaining wood ash generated as a byproduct of a timber processing operation; and
combining the moisture treated wood product particulate with the wood ash.

10. The process of claim 9, wherein the moisture source includes a binding agent, and wherein the step of exposing the wood product particulate to a moisture source comprises:
agitating the moisture source to thoroughly mix the binding agent; and
spraying the moisture source onto the wood product particulate.

11. A process for manufacturing an environmentally friendly soil and ground treatment compound, the process comprising the steps of:
obtaining a wood product particulate;
exposing the wood product particulate to a moisture source;
obtaining ash derived from the combustion of plant material; and
combining the moisture treated wood product particulate with the ash.

12. An environmentally responsible method for improving traction on an ice- or snow-covered surface, the method including the steps of:
obtaining a wood product particulate;
exposing the wood product particulate to a moisture source to form a moisture treated wood product particulate;
combining the moisture treated wood product particulate with a quantity of ash to form an anti-slip compound; and,
applying the anti-slip compound to the ice- or snow-covered surface.

13. The method of claim 12, wherein the moisture source includes a binding agent.

14. A renewable resource and energy process, the process comprising the steps of:
planting trees for use as a timber source;
harvesting the timber source trees;
using a first portion of the timber source trees to produce wood, paper products, and sawdust;
using a second portion of the timber source trees in a wood burning power plant to produce power and ash;
producing a fertilizer product using the sawdust and ash;
using the fertilizer product to accelerate the growth rate of the timber source trees.

15. The process of claim 14, further comprising the steps of:
using the fertilizer product to accelerate the growth rate of a field crop useful in the production of plant-based fuels;
producing a plant-based fuel and a plant matter by-product from the field crop;
producing a combustible fuel pellet from the plant matter by-product; and
burning the combustible fuel pellet to produce power.
